(19) United States
(12) Patent Application Publication
(10) Pub. No.: US 2026/0274633 A1
(43) Pub. Date: Sep. 17, 2026

(54) SAFETY DEVICE AND CONVEYING APPARATUS

(71) Applicant: GUANGDONG LEAD INTELLIGENT LOGISTICS TECHNOLOGY CO., LTD., Zhuhai (CN)

(72) Inventors: Yongchao Xu, Zhuhai (CN); Zhonghui Wang, Zhuhai (CN)

(73) Assignee: GUANGDONG LEAD INTELLIGENT LOGISTICS TECHNOLOGY CO., LTD., Zhuhai (CN)

(21) Appl. No.: 19/679,993

(22) Filed: May 18, 2026

Related U.S. Application Data
(63) Continuation of application No. PCT/CN2025/092970, filed on May 6, 2025.

(30) Foreign Application Priority Data
Nov. 11, 2024 (CN) 202422746590.4

(51) Int. Cl. B66F 17/00

(52) U.S. Cl. CPC B66F 17/006

(57) ABSTRACT

The disclosed subject matter provides a safety device and conveying apparatus. The safety device includes a floating structure, a safety gear, and a rope connection structure. The floating structure is configured to be slidably connected to the track of the frame and movable along the track of the frame. The safety gear is connected to a side of the floating structure adjacent to the frame. A first side of the rope connection structure is configured to be connected to the wire rope of the frame, and a second side of the rope connection structure is connected to the floating structure. The wire rope of the frame is adapted to slacking or breaking, and, in response thereto, the floating structure is configured to move and drive the safety gear to close, so that the safety gear locks onto the track of the frame.

### CROSS-REFERENCE TO RELATED APPLICATIONS

This application is a continuation of International Application No. PCT/CN2025/092970, filed on May 06, 2025, which claims priority to Chinese Patent Application No. 202422746590.4 filed on November 11, 2024, both of which are hereby incorporated by reference in their entireties.

### TECHNICAL FIELD

The embodiments of this application relate to the technical field of battery production, and particularly to a safety device and a conveying apparatus.

### BACKGROUND

In a production process of batteries, a cell tray handling apparatus plays a vital role in efficiently and accurately handling and stacking cell trays on the production line, and is a key apparatus for ensuring that the production process proceeds smoothly. The safety and stability of the cell tray handling apparatuses are directly related to production efficiency and product quality, and are even more an important prerequisite for guaranteeing safety of production personnel.

Currently, the anti-fall device of the cell tray handling apparatus suffers from a time lag, which may lead to an inability to take measures in time at an early stage of speed abnormality, increasing a probability of occurrence of accidents.

### SUMMARY

According to an aspect of the present application, a safety device is provided for controlling movement of a conveying platform.

The safety device includes:

a floating structure, configured to be slidingly connected to a track of a frame, and movable along the track of the frame;

a safety gear, connected to the side of the floating structure close to the frame; and

a rope connection structure, one side of which is configured for connecting to the wire rope of the frame, and the other side of which is connected to the floating structure;

wherein when the wire rope of the frame slackens or breaks, the floating structure is configured to move and drive the safety gear to close, so that the safety gear locks onto the track of the frame.

According to another aspect of the present application, a conveying apparatus is provided, including a frame, a conveying platform and the safety device; the conveying platform is slidably connected to the track of the frame and is movable along the track, and the safety device is connected to the side of the conveying platform close to the frame.

One technical effect of the embodiments of this application lies in:

The safety device includes a floating structure, a safety gear, and a rope connection structure. The floating structure is slidably connected to the track of the frame and movable along the track of the frame. The safety gear is connected to the side of the floating structure close to the frame. One side of the rope connection structure is connected to the wire rope of the frame, and the other side of the rope connection structure is connected to the floating structure. When the wire rope of the frame slackens or breaks, the floating structure is configured to move and drive the safety gear to close, so that the safety gear locks onto the track of the frame.

In this way, when the wire rope of the frame slackens or breaks, the movement of the floating structure can drive the safety gear to close quickly, so that the safety gear can lock onto the track of the frame in time when an abnormality occurs, so that the connected conveying platform can stop moving and avoid the risk of overturning of the conveying platform.

Other features and advantages of the embodiments of the application will become apparent from the following detailed description of exemplary embodiments of the application with reference to the drawings.

### BRIEF DESCRIPTION OF THE DRAWINGS

The drawings, which constitute a part of the specification, illustrate embodiments of the application and, together with the description, serve to explain the principles of the application.

FIG. 1 is a schematic diagram of a safety device according to an embodiment of this application;

FIG. 2 is another schematic diagram of a safety device according to an embodiment of this application;

FIG. 3 is yet another schematic diagram of a safety device according to an embodiment of this application;

FIG. 4 is a schematic diagram of a conveying apparatus according to an embodiment of this application;

FIG. 5 is another schematic diagram of a conveying apparatus according to an embodiment of this application;

FIG. 6 is a cross-sectional view at A-A in FIG. 5;

FIG. 7 is a partial schematic diagram at A in FIG. 6;

FIG. 8 is a schematic diagram of a safety device connected to a conveying platform according to an embodiment of this application;

FIG. 9 is another schematic diagram of a safety device connected to a conveying platform according to an embodiment of this application;

FIG. 10 is yet another schematic diagram of a safety device connected to a conveying platform according to an embodiment of this application;

FIG. 11 is a cross-sectional view at B-B in FIG. 10.

Description of reference signs:

100. Safety device; 200. conveying platform; 300. Frame;

1. Floating structure; 11. Body; 12. First connecting member; 13. Guide wheel; 2. Safety gear; 3. Rope connection structure; 4. First spring; 5. Sleeve; 6. Second spring; 7. Second connecting member; 8. Linkage structure; 9. Rotating shaft.

### DETAILED DESCRIPTION

Various exemplary embodiments of the application will now be described in detail with reference to the drawings. It should be noted that the relative arrangement of components and steps, the numerical expressions and numerical values set forth in these embodiments do not limit the scope of the present application unless specifically stated otherwise.

The following description of at least one exemplary embodiment is merely illustrative in nature and is in no way intended to limit the invention, its application, or uses.

Technologies and devices known to those skilled in the relevant art may not be discussed in detail, but where appropriate, such technologies and devices should be considered part of the specification.

In all examples shown and discussed herein, any specific values should be interpreted as merely exemplary and not limiting. Therefore, other examples of the exemplary embodiments may have different values.

It should be noted that like reference numerals and letters refer to like items in the following figures, and therefore, once an item is defined in one figure, it need not be further discussed in subsequent figures.

As an introduction to the embodiments of this application, an anti-fall device of a cell tray handling apparatus is introduced, which mainly relies on a linkage mechanism of a safety gear and a speed limiter. As a speed monitoring device, the speed limiter will trigger the safety gear when it detects that the upward or downward speed of the apparatus exceeds the preset safety threshold, thereby realizing emergency braking and fall protection for the apparatus. However, since the speed limiter only responds after an abnormal speed, and requires a certain delay before it can activate the safety gear to prevent the fall, this delay may lead to an inability to take measures in time at an early stage of speed abnormality, increasing a probability of occurrence of accidents.

The embodiments of this application provide a safety device 100 for controlling movement of a conveying platform 200. Herein, the conveying platform 200 is slidably connected to the track of the frame 300 and movable along the track of the frame 300. The safety device 100 is connected to conveying platform 200 and can move together with conveying platform 200. In abnormal circumstances, the safety gear 2 in the safety device 100 can close and lock onto the track of the frame 300, so that the conveying platform 200 can stop moving.

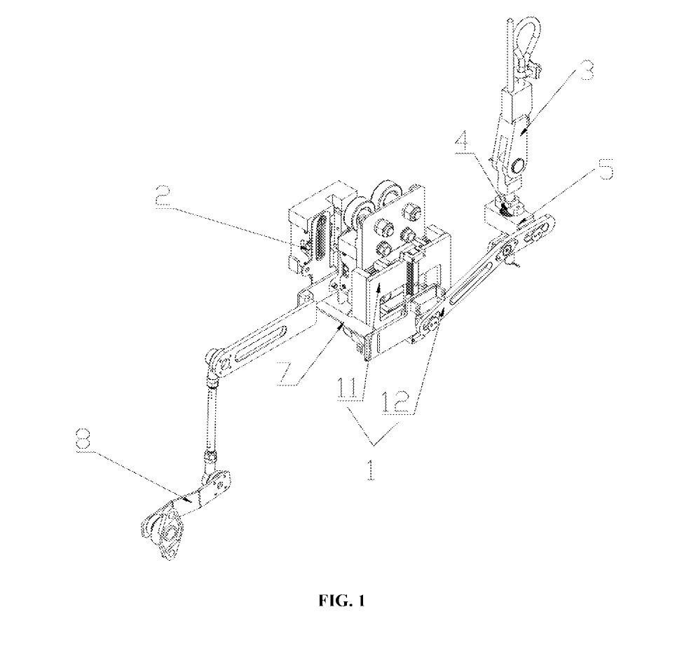

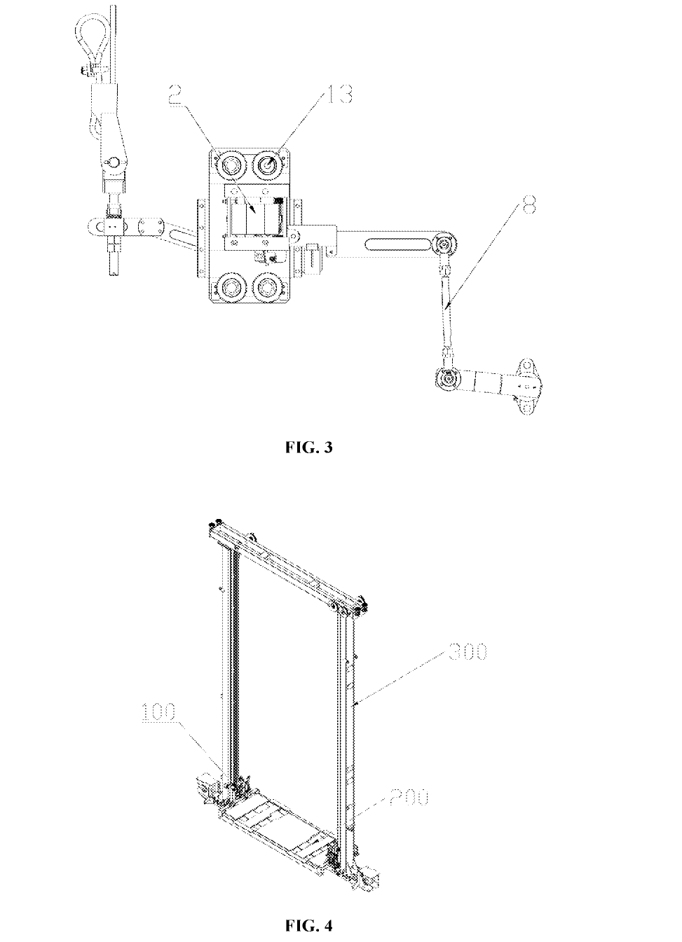

As shown in FIG. 1 to FIG. 3, the safety device 100 provided in this application includes:

a floating structure 1, slidingly connected to the track of the frame 300, and movable along the track of the frame 300;

a safety gear 2, connected to the side of floating structure 1 close to the frame 300; and

a rope connection structure 3, one side of which is configured for connecting to the wire rope of the frame 300, and the other side of which is connected to the floating structure 1;

when the wire rope of the frame 300 slackens or breaks, the floating structure 1 can move and drive the safety gear 2 to close, so that the safety gear 2 can lock onto the track of the frame 300.

Specifically, the floating structure 1 is configured to connect to the conveying platform 200 and can slide along the track of the frame 300 together with the conveying platform 200. Herein, the floating structure 1 may be equipped with a slide rail or roller that matches the track of the frame 300 to ensure the smoothness of the movement of the floating structure 1 on the track. Herein, the floating structure 1 can have a certain strength and rigidity to withstand the force generated when the safety gear 2 closes.

As shown in FIG. 1 to FIG. 3, the safety gear 2 is connected to the side of the floating structure 1 close to the track of the frame 300, that is, the safety gear 2 faces the track of the frame 300. When the wire rope of the frame 300 slackens or breaks, the safety gear 2 can close and lock onto the track of the frame 300 under the drive of the floating structure 1, so as to stop the connected conveying platform 200 from moving. Herein, the safety gear 2 maintains sufficient friction in the locked state, which can prevent the conveying platform 200 from sliding along the track.

As shown in FIG. 1 to FIG. 3, the rope connection structure 3 is configured to connect the wire rope of the frame 300 to the safety device 100 so that the safety device 100 can monitor the status of the wire rope. Specifically, one side of the rope connection structure 3 can be connected to the wire rope of the frame 300 through a wire rope clamp, while the other side of the rope connection structure 3 is fixedly connected to the floating structure 1, so that the floating structure 1 can move accordingly when the wire rope of the frame 300 slackens or breaks.

When the wire rope of the frame 300 is in normal condition, the safety gear 2 is in the open state and will not lock onto the track of the frame 300. At this time, the conveying platform 200 can drive the safety gear 2 to move together.

When the wire rope of the frame 300 slackens or breaks, the rope connection structure 3 will release the floating structure 1, allowing the floating structure 1 to move. As the floating structure 1 moves, the safety gear 2 connected to it can approach the track of the frame 300 until it closes and locks. At this time, the locking mechanism of the safety gear 2 will tightly bite the track of the frame 300 to prevent the frame 300 from sliding along the track, so that the connected conveying platform 200 stops moving.

Therefore, when the wire rope of the frame 300 slackens or breaks due to wear, breakage or operational errors, the safety device 100 of the embodiments of this application can respond quickly, so that the safety gear 2 can close in time and lock onto the track of the frame 300 tightly. This immediate response and automatic locking mechanism effectively prevents risks such as loss of control or fall of the conveying platform 200 due to wire rope failure.

Furthermore, the locking function of the safety gear 2 not only prevents the conveying platform 200 from falling, but also provides additional support and stability for the conveying platform 200 in emergency situations. This helps reduce secondary injuries or losses that may be caused by wire rope failure, and also improves the reliability and controllability of the conveying apparatus equipped with the safety device 100.

In addition, the safety device 100 may further include a speed limiter, a switch and a controller. When the movement speed of the conveying platform 200 exceeds the set speed of the speed limiter, the switch is opened, and the safety gear 2 can also be controlled to close through the controller. This enables dual triggering by the speed limiter and the wire rope, thereby improving the reliability of the safety device 100.

Optionally, the floating structure 1 includes a body 11 and a first connecting member 12, a first side of the first connecting member 12 is connected to the body 11, a second side of the first connecting member 12 is connected to the rope connection structure 3; and the safety gear 2 is connected to the body 11;

when the wire rope of the frame 300 slackens or breaks, the rope connection structure 3 can apply pressure to the second side, so that the first connecting member 12 can rotate about the second side and drive the first side to rise, so as to drive the safety gear 2 to close via the first side.

As shown in FIG. 1, the floating structure 1 can be designed as a combination of the body 11 and the first connecting member 12. The first connecting member 12 is connected to the wire rope of the frame 300 through the rope connection structure 3. When the wire rope of the frame 300 slackens or breaks, the rope connection structure 3 can quickly apply downward pressure to the second side of the first connecting member 12 under the action of gravity, so that the first connecting member 12 can rotate clockwise about the second side and drive the first side to rise along the track of the frame 300, thereby enabling the first side to drive the connected safety gear 2 to close and lock onto the track of the frame 300. This design optimizes the power transmission path and reduces response time, allowing the safety gear 2 to close more quickly to lock onto the track of the frame 300.

Herein, the safety gear 2 is connected to the body 11, rather than directly to the rope connection structure 3 or the frame 300. This arrangement also reduces the locking instability caused by losses and uncertainties in the power transmission process. When the rope connection structure 3 drives the first connecting member 12 to move, the body 11, as a stable support point, can ensure that the safety gear 2 maintains the correct position and angle during the closing process, thereby enhancing the stability and reliability of the locking.

In addition, the combined design of the body 11 and the first connecting member 12 not only optimizes the power transmission path, but also improves the strength and durability of the overall safety device 100. The body 11, as the main load-bearing part of the floating structure 1, can withstand the huge force when the safety gear 2 closes, while the first connecting member 12 is configured for transmitting power from the rope connection structure 3 to the body 11. This division of labor and cooperation allows each component to fully utilize its advantages, thereby improving the strength and durability of the overall safety device 100.

In another embodiment, the first connecting member 12 may further include multiple links that are drivingly connected, with the link connected to the rope connection structure 3 moving in the opposite direction to the link connected to the safety gear 2. When the wire rope of the frame 300 slackens or breaks, the link connected to the rope connection structure 3 can move downward and drive the link connected to the safety gear 2 to move upward, thereby driving the safety gear 2 to close and lock onto the track of the frame 300.

In yet another embodiment, a spring may be provided between the floating structure 1 and the track of the frame 300, and the spring is normally in a compressed state. When the wire rope of the frame 300 slackens or breaks, the spring elastic force can drive the floating structure 1 to rise and drive the safety gear 2 to close and lock onto the track of the frame 300.

Optionally, the safety device 100 also includes a first spring 4, one end of which is connected to the rope connection structure 3, the other end of which is connected to the second side, and the first spring 4 is in a compressed state;

when the wire rope of the frame 300 slackens or breaks, the first spring 4 can elastically recover and apply pressure to the second side.

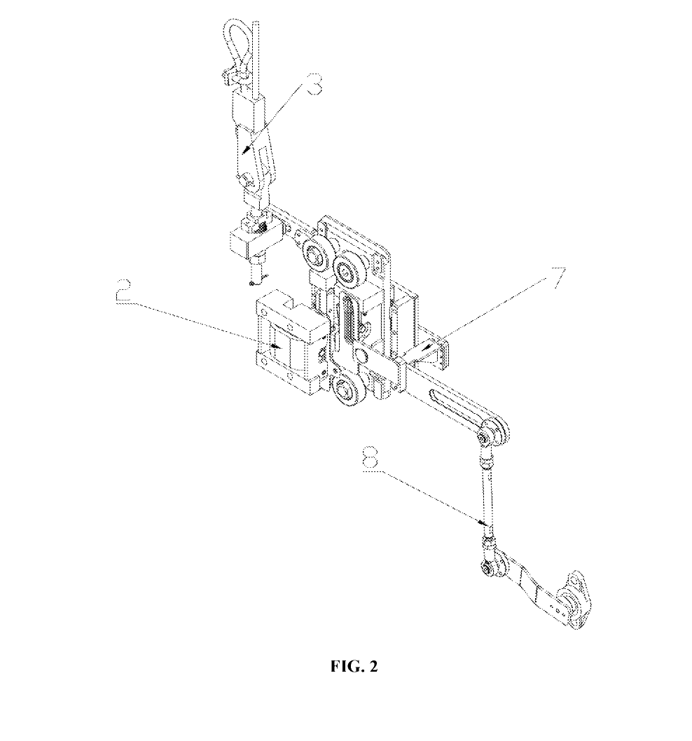

As shown in FIG. 1 and FIG. 2, when the wire rope of the frame 300 is in normal condition, the first spring 4 is compressed by the rope connection structure 3. At this time, the safety gear 2 is in the open state and will not lock onto the track of the frame 300, and the conveying platform 200 can drive the safety gear 2 to move together.

When the wire rope of the frame 300 slackens or breaks, the first spring 4 can elastically recover and apply pressure to the second side, so that the first connecting member 12 can rotate clockwise about the second side and drive the first side to rise. The rise of the first side can drive the safety gear 2 to close and lock. At this time, the locking mechanism of the safety gear 2 will tightly bite the track of the frame 300 to prevent the frame from sliding along the track, so that the connected conveying platform 200 stops moving. In this way, the first connecting member 12 can be rotated by the elastic force of the first spring 4, and the state of the safety gear 2 can be conveniently switched.

Optionally, the safety device 100 also includes a sleeve 5, and a connecting slot is formed in the second side. The sleeve 5 is connected to the connecting slot, and the first spring 4 extends into the sleeve 5.

As shown in FIG. 1 and FIG. 2, the sleeve 5 has a protrusion that extends into the connecting slot to connect the sleeve 5 to the second side. When the wire rope of the frame 300 slackens or breaks, the first spring 4 can elastically recover and apply pressure to the second side through the sleeve 5, so that the first connecting member 12 can rotate clockwise about the second side and drive the first side to rise. The rise of the first side can drive the safety gear 2 to close and lock. Furthermore, the sleeve 5 can also protect the first spring 4 that is disposed therein.

Optionally, the safety device 100 also includes a second spring 6, one side of which is connected to the first side, and the other side of which is configured to connect to the conveying platform 200, and the second spring 6 is in a stretched state.

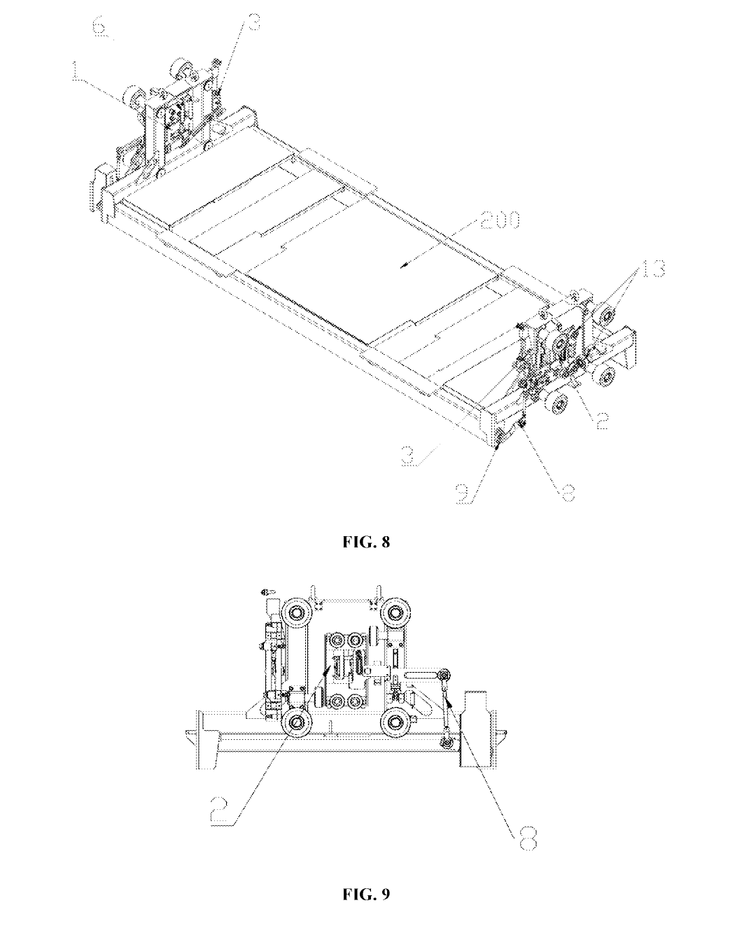

As shown in FIG. 8, when the wire rope of the frame 300 is in normal condition, the first spring 4 is compressed by the rope connection structure 3 and the second spring 6 is stretched by the floating structure 1. At this time, the safety gear 2 is in the open state and will not lock onto the track of the frame 300, and the conveying platform 200 can drive the safety gear 2 to move together.

When the wire rope of the frame 300 slackens or breaks, the first spring 4 can elastically recover and apply pressure to the second side, so that the first connecting member 12 can rotate clockwise about the second side and drive the first side to rise. The rise of the first side can drive the safety gear 2 to close and lock. At this moment, the second spring 6 can elastically recover under the action of elastic force, thereby ensuring the reliability of the rotation of the first connecting member 12.

Optionally, the safety device 100 also includes a second connecting member 7, one side of which is connected to the floating structure 1, and the other side of which is connected to the safety gear 2.

As shown in FIG. 1 and FIG. 2, the design of the second connecting member 7 provides a connection point between the floating structure 1 and the safety gear 2, which not only enhances the connection strength between the two, but also improves the stability of the overall structure. In an emergency situation, such as when the wire rope of the frame 300 slackens or breaks, the second connecting member 7 can ensure that the safety gear 2 closes stably and reliably, preventing safety hazards caused by loose or broken connections. Herein, the second connecting member 7 can be a connecting plate to facilitate assembly.

Herein, with the second connecting member 7, the floating structure 1 can more smoothly and accurately push the safety gear 2 to close when it is driven by the rope connection structure 3, thereby optimizing the power transmission path and reducing the problem of poor locking effect caused by power dispersion or poor transmission. Furthermore, the second connecting member 7 can also serve as a buffer and shock absorber, and can also protect the floating structure 1 and the safety gear 2 from impact damage caused by sudden changes in power.

Optionally, the safety device 100 also includes two linkage structures 8, wherein the safety device 100 includes two safety gears 2, two floating structures 1, and two rope connection structures 3. The linkage structures 8 are configured to drive the two safety gears 2 to close to jointly lock onto the track of the frame 300.

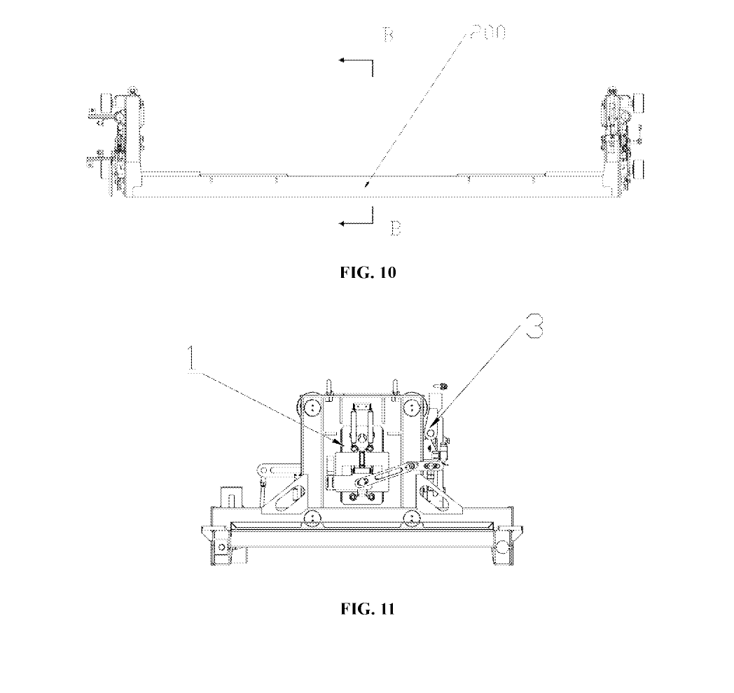

As shown in FIG. 8 to FIG. 11, each side of the conveying platform 200 is connected to a locking group consisting of a safety gear 2, a floating structure 1, a rope connection structure 3, and a linkage structure 8. In case of an abnormality, the safety gears 2 in both locking groups can close and lock onto the track of the frame 300 from both sides, thereby stopping the movement of the conveying platform 200 and stably fixing the conveying platform 200 on the track of the frame 300, thus avoiding risks such as overturning of the conveying platform 200.

Herein, the linkage structure 8 can be a multi-link structure composed of multiple links that are drivingly connected, and the two linkage structures 8 can be connected in a transmission manner by links, rotating shafts 9, etc.

Optionally, the safety device 100 also includes a rotating shaft 9, wherein each of two ends of the rotating shaft 9 is connected to one of the linkage structures 8, and each linkage structure 8 is connected to one of the safety gear 2. As shown in FIG. 8, the conveying platform 200 is provided with a through hole, through which the rotating shaft 9 is inserted, with one linkage structure 8 connected to each end of the rotating shaft 9. This allows the linkage structures 8 on both sides to be connected in a transmission manner, thereby enabling synchronous control of the two safety gears 2 and improving the reliability and controllability of the safety device 100.

Optionally, the floating structure 1 has a guide wheel 13 for slidingly connecting to the track of the frame 300. As shown in FIG. 8, the floating structure 1 may be designed with guide wheels 13, i.e. rollers, that match the track of the frame 300 to ensure the smoothness of the movement of the floating structure 1 on the track.

This application also provides a conveying apparatus, including a frame 300, a conveying platform 200 and a safety device 100, wherein the conveying platform 200 is slidably connected to the track of the frame 300 and is movable along the track, and the safety device 100 is connected to the side of the conveying platform 200 close to the frame 300.

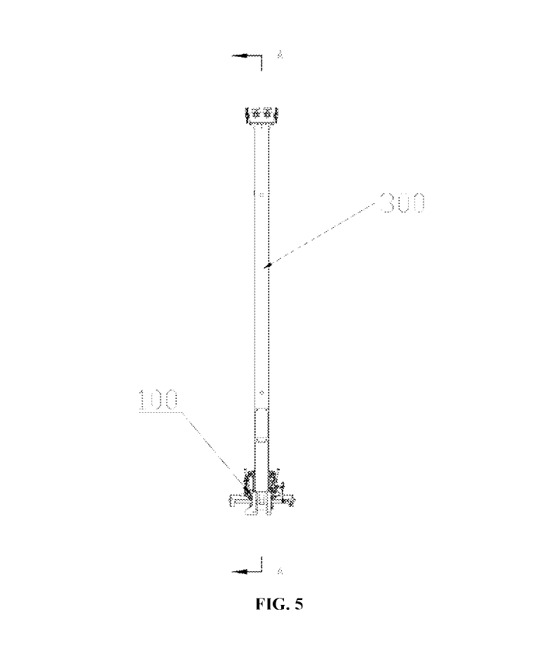

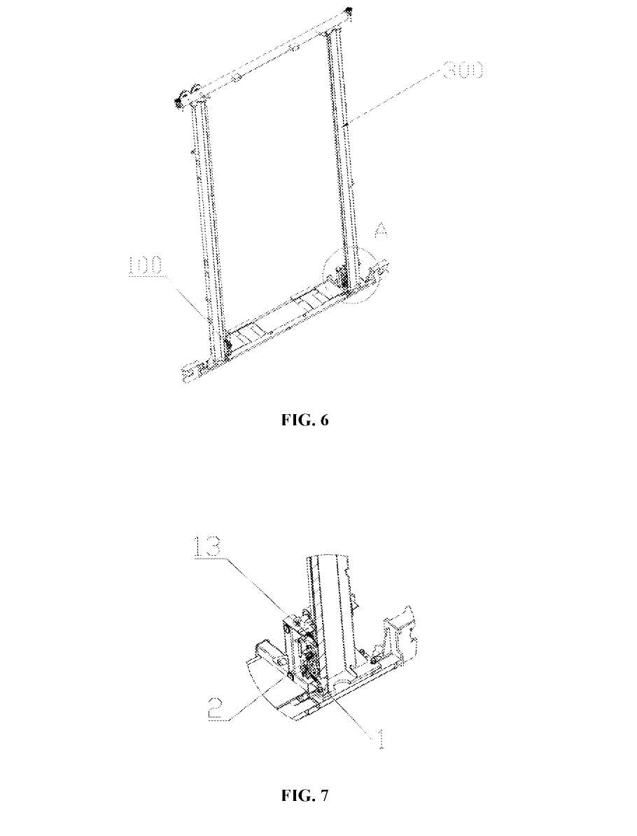

As shown in FIG. 4 to FIG. 7, the conveying platform 200 is slidably connected to the track of the frame 300 and can move along the track of the frame 300. The safety device 100 is connected to the conveying platform 200 and can move with the conveying platform 200. Herein, the conveying apparatus can be a battery cell tray handling apparatus, which is configured to handle battery cell trays.

When the wire rope of the frame 300 slackens or breaks due to wear, breakage or operational errors, the safety device 100 can respond quickly, so that the safety gear 2 can close in time and lock onto the track of the frame 300 tightly. This immediate response and automatic locking mechanism effectively prevents risks such as loss of control or fall of the conveying platform 200 due to wire rope failure.

The above embodiments mainly describe the differences between the various embodiments. As long as the different optimization features between the various embodiments are not contradictory, they can be combined to form a better embodiment. For the sake of brevity, they will not be elaborated here.

Although some specific embodiments of this application have been described in detail by way of examples, those skilled in the art should understand that the above examples are for illustrative purposes only and are not intended to limit the scope of this application. Those skilled in the art should understand that modifications can be made to the above embodiments without departing from the scope and spirit of this application. The scope of the application is defined by the appended claims.

1. A safety device, configured to control a movement of a conveying platform, the safety device comprising:
a floating structure, configured to be slidingly connected to a track of a frame, and movable along the track of the frame;
a safety gear, connected to a side of the floating structure adjacent to the frame; and
a rope connection structure, having a first side configured for connecting to a wire rope of the frame and a second side connected to the floating structure;
wherein the wire rope of the frame is adapted to be slacking or breaking, and, in response thereto, the floating structure is configured to move and drive the safety gear to close, so that the safety gear locks the track of the frame.

2. The safety device according to claim 1, wherein the floating structure comprises a body and a first connecting member, a first side of the first connecting member is connected to the body, a second side of the first connecting member is connected to the rope connection structure, and the safety gear is connected to the body;
wherein the wire rope of the frame is adapted to be slacking or breaking, and, in response thereto, the rope connection structure is configured to apply pressure to the second side of the first connecting member, so that the first connecting member rotates around the second side of the first connecting member and drives the first side of the first connecting member to rise, so as to drive the safety gear to close via the first side of the first connecting member.

3. The safety device according to claim 2, further comprising a first spring having a first end connected to the rope connection structure and a second end connected to the second side, and the first spring is in a compressed state;
wherein the wire rope of the frame is adapted to be slacking or breaking, and, in response thereto, the first spring is configured to elastically recover and apply pressure to the second side of the first connecting member.

4. The safety device according to claim 3, further comprising a sleeve, and a connecting slot is formed in the second side of the first connecting member, wherein the sleeve is connected to the connecting slot, and the first spring extends into the sleeve.

5. The safety device according to claim 2, further comprising a second spring having a first side connected to the first side and a second side configured to connect to the conveying platform, and the second spring is in a stretched state.

6. The safety device according to claim 1, further comprising a second connecting member having a first side connected to the floating structure and a second side connected to the safety gear.

7. The safety device according to claim 1, further comprising two linkage structures; wherein the safety device comprises two safety gears, two floating structures, and two rope connection structures; wherein the two linkage structures are configured to drive the two safety gears to close and jointly lock the track of the frame.

8. The safety device according to claim 7, further comprising a rotating shaft, wherein each of two ends of the rotating shaft is connected to each of the two linkage structures, and each of the two linkage structures is further connected to the safety gear.

9. The safety device according to claim 1, wherein the floating structure has guide wheels, and the guide wheels are configured to be slidably connected to the track of the frame.

10. A conveying apparatus, comprising a frame, a conveying platform, and a safety device according to claim 1;
wherein the conveying platform is slidably connected to the track of the frame and is movable along the track, and the safety device is connected to a side of the conveying platform adjacent to the frame.
